(19) United States
(12) Patent Application Publication
(10) Pub. No.: US 2026/0270303 A1
(43) Pub. Date: Sep. 10, 2026

(54) METHOD, APPARATUS, ELECTRONIC DEVICE AND STORAGE MEDIUM FOR MULTI-PERSON LIVE VIDEO STREAMING

(71) Applicant: Beijing Zitiao Network Technology Co., Ltd., Beijing (CN)

(72) Inventors: Weichao WANG, Beijing (CN); Hang CHEN, Beijing (CN); Wei HAN, Beijing (CN)

(21) Appl. No.: 19/491,281

(22) PCT Filed: Jun. 6, 2024
(86) PCT No.: PCT/CN2024/097855

§ 371 Date: Dec. 8, 2025

(30) Foreign Application Priority Data
Jun. 8, 2023 (CN) 202310679137.3

(51) Int. Cl. H04L 65/1089; G06T 7/11; G06T 19/00; H04L 65/1069; H04L 65/1093; H04L 65/401

(52) U.S. Cl. CPC H04L 65/1089; G06T 7/11; G06T 19/00; H04L 65/1069; H04L 65/1093; H04L 65/4015; G06T 2207/10016; G06T 2219/024

(57) ABSTRACT

A method, an apparatus, a device and a storage medium for multi-person live video streaming are provided. The method includes: creating a three-dimensional live streaming room; creating a first target image in the three-dimensional live streaming room based on a first video live stream sent by a first terminal device, where the first terminal device corresponds to a streamer, and the first target image represents a live streaming room picture of a two-dimensional live streaming room corresponding to the first video live stream; and sending a second video live stream corresponding to the three-dimensional live streaming room to a target terminal device, the target terminal device includes the first terminal device and/or a second terminal device, and the second terminal device corresponds to a viewer.

This application claims priority to Chinese Patent Application No. 202310679137.3, filed Jun. 8, 2023, entitled “METHOD, APPARATUS, ELECTRONIC DEVICE AND STORAGE MEDIUM FOR MULTI-PERSON LIVE VIDEO STREAMING”, the entire contents of which are incorporated herein by reference.

### FIELD

Embodiments of the present disclosure relates to the technical field of the Internet, in particular to a method, an apparatus, and an electronic device and a storage medium of multi-person live video streaming.

### BACKGROUND

Currently, in an application scenario of live video streaming, multi-person live streaming refers to common live streaming between a plurality of streamers through a video connection, so that a viewer can watch interactions between the plurality of streamers, thereby improving an effect of live video streaming.

However, in the related technology, a way for implementing multi-person live streaming generally involves split-screen display for each of the streamers, which leads to a problem of strong space splitting and poor visual effect, and affects an overall live streaming effect in the multi-person live streaming.

### SUMMARY

The embodiments of the present disclosure provide a method, an apparatus, and an electronic device and a storage medium of multi-person live video streaming, aiming to overcome the problems of strong space splitting and poor visual effect in a streamer image during the multi-person live streaming.

According to a first aspect, an embodiment of the present disclosure provides a method of multi-person live video streaming, applied at a host terminal device, including: creating a three-dimensional live streaming room; creating a first target image in the three-dimensional live streaming room based on a first video live stream sent by a first terminal device, where the first terminal device corresponds to a streamer, and the first target image represents a live streaming room picture of a two-dimensional live streaming room corresponding to the first video live stream; and sending a second video live stream corresponding to the three-dimensional live streaming room to a target terminal device, where the target terminal device includes the first terminal device and/or a second terminal device, and the second terminal device corresponds to a viewer.

According to a second aspect, an embodiment of the present disclosure provides a method of multi-person live video streaming, applied at a first terminal device, including: entering a three-dimensional live streaming room; sending a first video live stream to a host terminal device which is configured to create the three-dimensional live streaming room, to create a first target image in the three-dimensional live streaming room, where the first target image represents an streamer image picture in the first video live stream; and receiving a second video live stream corresponding to the three-dimensional live streaming room, and playing the second video live stream.

According to a third aspect, an embodiment of the present disclosure provides an apparatus for multi-person live video streaming, including: a creating module configured to create a three-dimensional live streaming room; a generating module configured to create a first target image in the three-dimensional live streaming room based on a first video live stream sent by a first terminal device, where the first terminal device corresponds to a streamer, and the first target image represents a live streaming room picture of a two-dimensional live streaming room corresponding to the first video live stream; and a transceiving module configured to send a second video live stream corresponding to the three-dimensional live streaming room to a target terminal device, where the target terminal device includes the first terminal device and/or a second terminal device, and the second terminal device corresponds to a viewer.

According to a fourth aspect, an embodiment of the present disclosure provides an apparatus for multi-person live video streaming, including: a processing module configured to enter a three-dimensional live streaming room; a sending module configured to send a first video live stream to a host terminal device which is configured to create the three-dimensional live streaming room, to create a first target image in the three-dimensional live streaming room, where first terminal device corresponds to the streamer, the first target image represents an image picture of the live streaming room in the two-dimensional live streaming room corresponding to the first video live stream; and a receiving module configured to receive a second video live stream corresponding to the three-dimensional live streaming room, and play the second video live stream.

According to a fifth aspect, an embodiment of the present disclosure provides an electronic device, including: a processor, and a memory communicatively connected to the processor; the memory storing computer-executable instructions; the processor executing the computer-executable instructions stored in the memory, to implement the method of multi-person live video streaming according to the first aspect and various possible designs of the first aspect, or to implement the method of multi-person live video streaming according to the second aspect and the possible designs of the second aspect.

According to a sixth aspect, an embodiment of the present disclosure provides a computer-readable storage medium, the computer-readable storage medium storing computer-executable instructions, and when the processor executes the computer-executable instructions, implementing the multi-person live video streaming method according to the first aspect and the possible designs of the first aspect is implemented, or the multi-person live video streaming method according to the second aspect and the possible designs of the second aspect is implemented.

According to a seventh aspect, an embodiment of the present disclosure provides a computer program product, including a computer program which, when executed by a processor, implements the method of multi-person live video streaming according to the first aspect and various possible designs of the first aspect, or implements the method of multi-person live video streaming according to the second aspect and the possible designs of the second aspect.

### BRIEF DESCRIPTION OF DRAWINGS

In order to more clearly illustrate the embodiments of the present disclosure or the technical solutions in the related technology, the accompanying drawings used in the description of the embodiments or the related technology will be briefly introduced below, and it will be apparent that the drawings in the following description are some embodiments of the present disclosure, and those skilled in the art may also obtain other drawings according to these drawings without creative labor.

FIG. 1 is an application scenario diagram of a method of multi-person live video streaming according to an embodiment of the present disclosure;

FIG. 2 is a schematic flowchart 1 of a method of multi-person live video streaming according to an embodiment of the present disclosure;

FIG. 3 is a schematic diagram of creating a first target image in a three-dimensional live streaming room according to an embodiment of the present disclosure;

FIG. 4 is a flowchart of a specific implementation of step S102 in the embodiment shown in FIG. 2;

FIG. 5 is a flowchart of a specific implementation of step S104 in the embodiment shown in FIG. 2;

FIG. 6 is a flowchart of a specific implementation of step S105 in the embodiment shown in FIG. 2;

FIG. 7 is a schematic diagram of moving a target virtual object in a three-dimensional live streaming room according to an embodiment of the present disclosure;

FIG. 8 is a schematic flowchart 2 of a method of multi-person live video streaming according to an embodiment of the present disclosure;

FIG. 9 is a flowchart of a specific implementation of step S208 in the embodiment shown in FIG. 8;

FIG. 10 is a schematic diagram of determining a target display direction according to an embodiment of the present disclosure;

FIG. 11 is a schematic flowchart 3 of a method of multi-person live video streaming according to an embodiment of the present disclosure;

FIG. 12 is a structural block diagram of an apparatus for multi-person live video streaming according to an embodiment of the present disclosure;

FIG. 13 is a structural block diagram of another apparatus for multi-person live video streaming according to an embodiment of the present disclosure;

FIG. 14 is a schematic structural diagram of an electronic device according to an embodiment of the present disclosure;

FIG. 15 is a schematic diagram of a hardware structure of an electronic device according to an embodiment of the present disclosure.

### DETAILED DESCRIPTION

In order to make the objectives, technical solutions and advantages of the embodiments of the present disclosure clearer, the technical solutions in the embodiments of the present disclosure will be clearly and completely described below with reference to the accompanying drawings in the embodiments of the present disclosure. All other embodiments obtained by those skilled in the art based on the embodiments of the present disclosure without creative labor shall fall within the scope of the present disclosure.

It should be noted that the request information (including but not limited to user equipment information, user personal information, etc.) and data (including but not limited to data for analysis, stored data, displayed data, etc.) involved in the present disclosure are all information and data authorized by the user or sufficiently authorized by the parties, and the collection, use and processing of the related data shall comply with the relevant laws and regulations and standards of the relevant countries and regions, and a corresponding operation portal will be provided for the user to select authorization or decline.

The following describes an application scenario of the embodiments of the present disclosure.

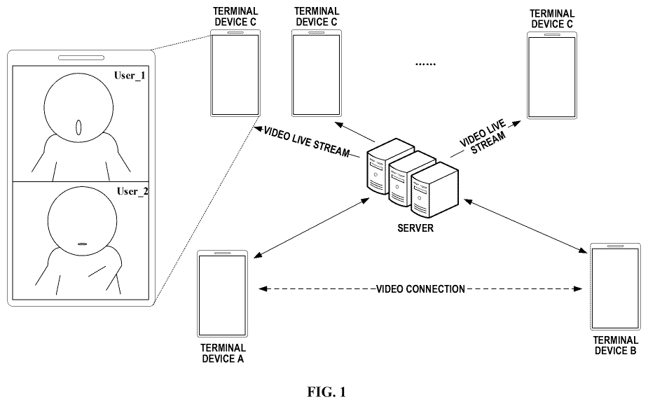

The method of multi-person live video streaming provided by the embodiments of the present disclosure can be applied at an application scene of multi-person connection live streaming. FIG. 1 is an application scenario diagram of the method of multi-person live video streaming according to an embodiment of the present disclosure. For example, taking a terminal device A used by a streamer User_1 as an example, after running the live streaming application client (Application, APP), the terminal device A creates a live video streaming room for live video streaming in response to a user instruction. Then, a streamer User_1 may perform video connection through the terminal device A and a terminal device B used by a streamer User_2, which also referred to as “connection PK”. After the video connection is established, the video image of the streamer User_1 and the video image of the streamer User_2 are simultaneously displayed in the live streaming application client on the side of the terminal device A (and may also be displayed on the terminal device B at the same time based on the requirement), thereby implementing multi-person interactive live streaming between the multiple streamers. Meanwhile, the video live stream of the live streaming room is distributed to a terminal device C used by a viewer through the server, so that the viewer can watch the live streaming content of the multi-person live streaming in the live streaming room.

In the related technology, as shown in FIG. 1, a way for implementing multi-person live streaming generally involves split-screen display for each of the streamers, which leads to a problem of strong space splitting and poor visual effect, and affects an overall live streaming effect in the multi-person live streaming. The present disclosure provides a method of multi-person live video streaming to solve the above question.

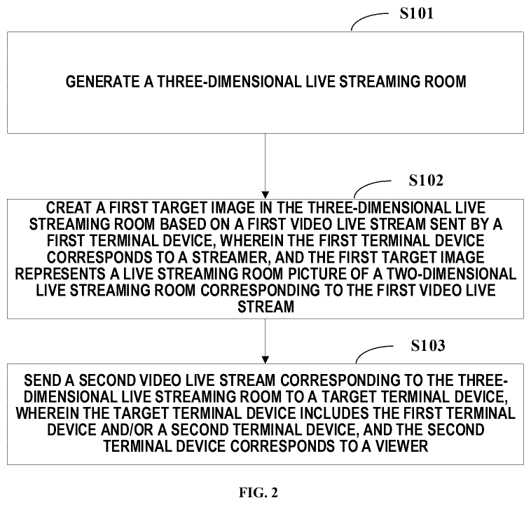

Referring to FIG. 2, FIG. 2 is a schematic flowchart 1 of the method of multi-person live video streaming according to an embodiment of the present disclosure. The method in this embodiment may be applied at a live video streaming server or a host terminal device. In this embodiment, an example is described with the method applied at the host terminal device (which may be a terminal corresponding to a host/room-owner user). For example, the method of multi-person live video streaming provided in this embodiment includes the following steps:

Step S101: a three-dimensional live streaming room is created.

For example, referring to the schematic application scenario shown in FIG. 1, after running the live streaming application, the host terminal device may create a three-dimensional live streaming room in response to a room creation instruction of a user, where the three-dimensional live streaming room is based on a live streaming room in a three-dimensional form. In the application scenario of live video streaming, a live streaming room is a logical unit for outputting a video live stream provided by a server of a live streaming application, and a viewer entering the live streaming room may receive a live video stream corresponding to the live streaming room, so as to watch live streaming content in the live streaming room. The live streaming room in the related technology is a two-dimensional live streaming room, that is, the video content corresponding to the streamer is displayed on a fixed plane background, and the data forming the two-dimensional live streaming room includes a live data stream and a flat image. Therefore, in a scenario of multi-person live streaming, a two-dimensional live streaming room receives live data streams of different viewers, and displays live images of the different streamers on the flat image in a zoned display manner.

In this embodiment, the three-dimensional live streaming room may be a live streaming room having a three-dimensional stereoscopic effect constructed by using a three-dimensional image engine, and the data constituting the three-dimensional live streaming room includes image model data and a video live stream corresponding to the three-dimensional live streaming room.

The three-dimensional live streaming room provided in this embodiment is a three-dimensional live streaming room, which needs operations such as three-dimensional image data loading and three-dimensional live streaming room rendering to create the three-dimensional live streaming room. Further, a virtual object(s) may be included in the created three-dimensional live streaming room. Different virtual environment scenes may be displayed through the virtual object(s), so as to simulate a real environment scene, for example, a concert scene, a variety show scene, a game scene, and the like. The implementations of specific content in the three-dimensional live streaming room and the overall virtual scene may be selected through a user instruction, and the three-dimensional live streaming room may be initialized and created through the existing three-dimensional game engine, and the specific implementations are not described herein again.

Step S102: a first target image in the three-dimensional live streaming room is created based on a first video live stream sent by a first terminal device, where the first terminal device corresponds to a streamer, and the first target image represents a live streaming room picture of a two-dimensional live streaming room corresponding to the first video live stream.

For example, after the host terminal device creates the three-dimensional live streaming room, the user operating the host terminal device may be considered as a host/room-owner user. Then, the host/room-owner user may send invitation information to the first terminal device(s) corresponding to the one or more streamers through the host terminal device, to enable the streamer(s) to join the three-dimensional live streaming room. Alternatively, the streamer(s) directly joins the three-dimensional live streaming room by receiving a link push, an autonomous search, and the like. After the streamer(s) joins the three-dimensional live streaming room, it means that a connection state is established between the first terminal device(s) corresponding to the streamer(s) and the host terminal device creating the three-dimensional live streaming room. Then, a first terminal device sends a first video live stream to the host terminal device in a direct or indirect way, and the host terminal device renders video content in the first video live stream into the three-dimensional live streaming room, so as to generate a first target image representing a streamer image picture in the first video live stream in the three-dimensional live streaming room.

FIG. 3 is a schematic diagram of creating a first target image in a three-dimensional live streaming room according to an embodiment of the present disclosure. As shown in FIG. 3, For example, after creating the three-dimensional live streaming room, the host terminal device renders a corresponding three-dimensional live streaming room. Referring to FIG. 3, a three-dimensional live streaming room includes a virtual object rendered based on a three-dimensional image engine, such as a stage, an auditorium, and an audience on an auditorium. Then, the host terminal device receives the first video live stream steam_1 (shown as steam_1) corresponding to the streamer U1 sent by the terminal device D2_1, and the first video live stream steam_2 (shown as steam_2) corresponding to the streamer U2 sent by the terminal device D2_2. The host terminal device sets the live streaming image P1 generated based on the first video live stream steam_1 and the live streaming image P2 generated based on the first video live stream steam_2 (the live streaming image P1 and the live streaming image P2 are the first target image) to be played at the pos_1 and pos_2 positions in the three-dimensional live streaming room. Therefore, the image picture of the streamer U1 and the image picture of the streamer U2 are located in the three-dimensional live streaming room at the same time, so that the image picture of the streamer and the virtual environment are fused.

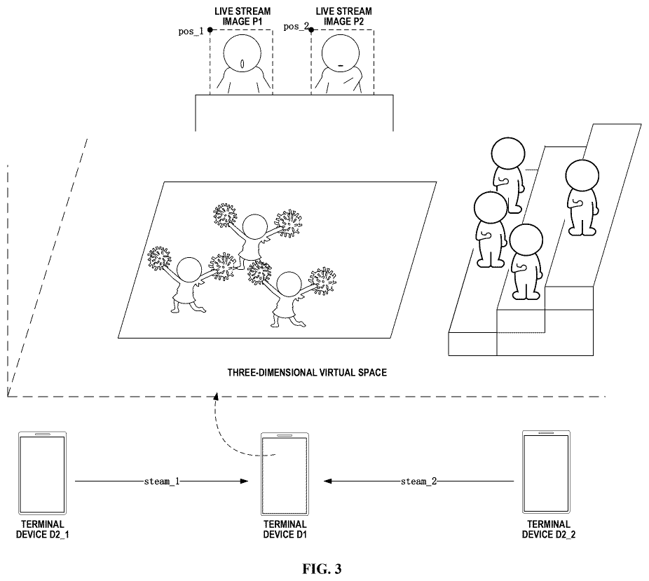

In a possible implementation, after receiving the first video live stream, the host terminal device first processes the first video live stream, divides a streamer image portion from a background portion, and then generates a first target image in the three-dimensional live streaming room. It makes the first target image generated in the three-dimensional live streaming room finer and realistic. For example, as shown in FIG. 4, a specific implementation of step S102 includes the following steps.

Step S1021: a target region of a live streaming image frame in the first video live stream is determined, the target region being a region where a streamer image locates in the live streaming image frame.

Step S1022: the first target image is generated by segmenting the live streaming image frame based on the target region.

Step S1023: the first target image is set into the three-dimensional live streaming room.

For example, after obtaining the first video live stream, the host terminal device may obtain the corresponding live image frame through necessary decoding processing, and the specific implementation process is the related technology, details of which are not described herein again. Then, the host terminal device performs image recognition and segmentation on each live image frame, divides the image in a target area where the streamer image in the live image frame is located, and discards the image of the area other than the streamer image in the live image frame, to obtain the streamer image with the background removed, i.e., the first target image. In a possible implementation, the target area in the above live image frame may be determined by an image color in the live image frame. For example, if the first video live stream is generated after the first terminal device captures the streamer by using a green screen, the character background is green in the live image frame of the first video live stream. Thus, the host terminal device may divide the target area through the color. In another possible implementation, the host terminal device may determine a contour of an image element in the live image frame, and perform feature recognition on the image element, which may also determine the target area therein. The specific implementation manner of determining the target area may be set according to specific conditions, which is not specifically limited herein.

For example, optionally, after step S101, the method further includes the following steps.

Step S104: after the viewer enters the three-dimensional live streaming room, a target virtual object corresponding to the viewer in the three-dimensional live streaming room is generated.

For example, the three-dimensional live streaming room includes at least one first spatial position and/or at least one second spatial position, where the first spatial position is configured to display a first target image, and the second spatial position is configured to display a virtual object. The first spatial position is determined based on first request information of a streamer entering the three-dimensional live streaming room, and the second spatial position is determined based on second request information of the viewer entering the three-dimensional live streaming room.

For example, the first request information, that is, an identifier of a streamer entering the target live streaming room, and the second request information is an identifier of an viewer entering the target host. The host terminal device may obtain the first request information and the second request information through a server of the live streaming application. Further, a first spatial position in which the first target image is located and a second spatial position in which the virtual object is located are set based on the first request information and the second request information. For example, the corresponding first spatial position is determined according to the degree of association between the streamer and the host/room-owner user. For another example, the corresponding second spatial position is determined according to the degree of association between the audience user and the anchor user.

In this embodiment, the corresponding spatial position is determined by obtaining the identifier of the streamer and the viewer, the position control of more accurate image elements can be achieved in the three-dimensional live streaming room, and the simulation scene represented by the three-dimensional live streaming room is more realistic.

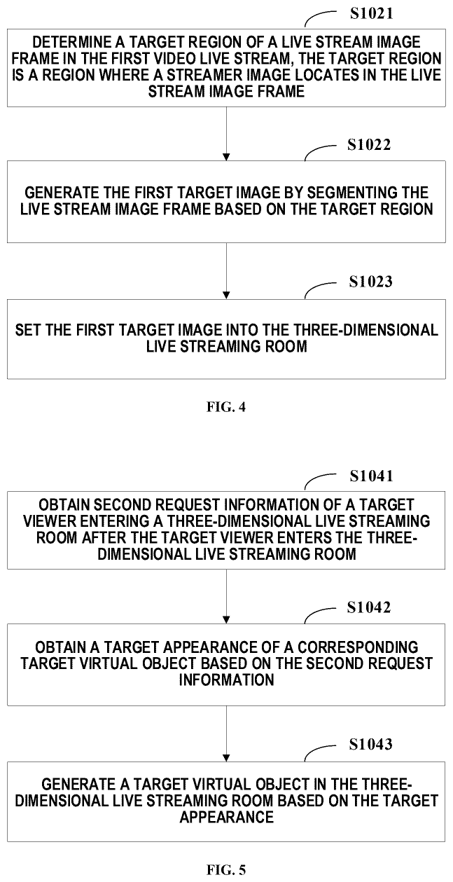

Further, based on the introduction in the previous embodiment steps, for the streamer in the three-dimensional live streaming room, the interaction between the streamers may be achieved by displaying the video image including streamer image in the three-dimensional live streaming room. However, for viewers entering the three-dimensional live streaming room, differentiated display cannot be performed in the three-dimensional live streaming room, and interaction with the streamer cannot be performed. To solve the above problem, as shown in FIG. 5, a specific implementation of step S104 includes the following steps.

Step S1041, after a target viewer enters the three-dimensional live streaming room, second request information of the target viewer entering the three-dimensional live streaming room is obtained.

Step S1042, a target appearance of the corresponding target virtual object is obtained based on the second request information.

Step S1043, a target virtual object in the three-dimensional live streaming room is generated based on the target appearance.

For example, there is a preset mapping relationship between the second request information and the appearance of the virtual object. For example, the live streaming room level represented by the second request information is mapped to a corresponding appearance color. Therefore, the target appearance of the corresponding target virtual object can be obtained based on the second request information and the mapping relationship. Then, the target virtual object is rendered into the three-dimensional live streaming room by taking the target appearance as a rendering parameter, to achieve the purpose of generating the target virtual object corresponding to the second request information in the three-dimensional live streaming room. The foregoing mapping relationship is merely an example, and a specific mapping implementation between the second request information representation and the target appearance may be set as needed, which is not specifically limited herein.

Further, optionally, after step S104, the method further includes the following steps.

Step S105, in response to an action request sent by the second terminal device, the target virtual object is controlled to move in the three-dimensional live streaming room.

For example, the viewer may directly or indirectly send the action request to the host terminal device by operating the second terminal device. For example, after triggering the specified component and prop on one side of the second terminal device, the second terminal device sends the action request to the host terminal device through the server. After receiving the action request, the host terminal device determines a target viewer corresponding to the action request, and further determines a target virtual object corresponding to the target audience user in the three-dimensional live streaming room, for example, the target virtual object produced by the three-dimensional image engine. Then, the host terminal device controls the virtual object to move in the three-dimensional live streaming room based on the specific content represented by the action request. Therefore, it can achieve interaction and communication between the viewer and the streamer.

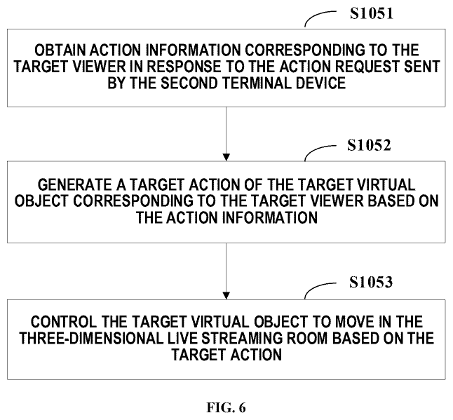

As shown in FIG. 6, for example, the specific implementation of step S105 includes the following steps.

Step S1051, action information corresponding to the target viewer is obtained in response to the action request sent by the second terminal device.

Step S1052, a target action of the target virtual object corresponding to the target viewer is generated based on the action information.

Step S1053, the target virtual object is controlled to move in the three-dimensional live streaming room based on the target action.

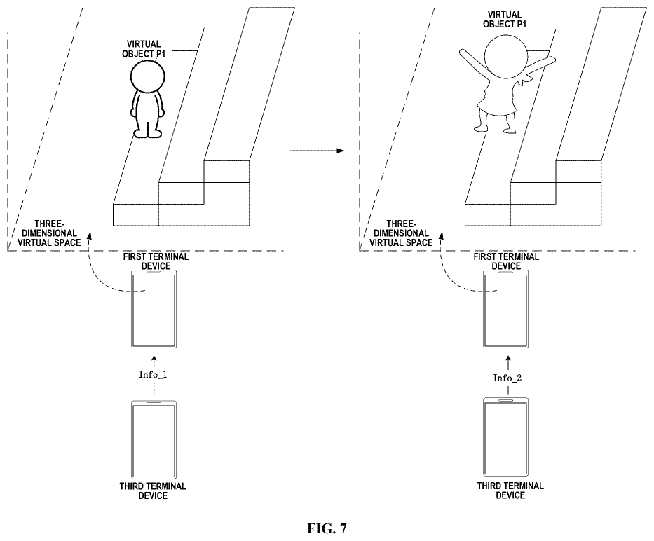

FIG. 7 is a schematic diagram of moving a target virtual object in a three-dimensional live streaming room according to an embodiment of the present disclosure. As shown in FIG. 7, after the target viewer enters the three-dimensional live streaming room, the host terminal device receives the entry message Info_1 (shown as Info_1), where the message Info_1 may be sent by the second terminal device to the host terminal device indirectly through the server. Then, the host terminal device creates a corresponding target virtual object P1 for the target viewer in the virtual three-dimensional space corresponding to the three-dimensional live streaming room. In an initial state, the virtual object P1 is in a standing posture of hanging down two arms. Then, after the host terminal device receives the action information Info_2 (shown in the figure as Info_2) sent indirectly by the first terminal device D2 by using the server, the host terminal device determines a corresponding target action based on the action information Info_2, for example, is a cheering action of lifting two hands, and controls the virtual object P1 to move based on the target action, so as to make the cheering action of lifting two hands, thereby realizing the control of the viewer on the corresponding virtual object in the three-dimensional live streaming room. This enables the interaction between the viewer and the streamer, and the interaction between the viewer and viewer user, improves the interaction effect of the three-dimensional live streaming room and the overall live streaming effect in the multi-person live streaming scene.

Step S103, a second video live stream corresponding to the three-dimensional live streaming room is sent to the target terminal device, where the target terminal device includes the first terminal device and/or the second terminal device, and the second terminal device corresponds to the viewer user.

For example, after the host terminal device generates the first target image and the virtual object in the created three-dimensional live streaming room, the data corresponding to the three-dimensional live streaming room is rendered as the corresponding live streaming data stream, that is, the second video live stream, and uploaded to the server of the live streaming application. Then, the server of the live streaming application distributes the second video live stream to the first terminal device and/or the second terminal device, that is, the target terminal device. Therefore, the first terminal device and/or the second terminal device can watch the image in the actual three-dimensional live streaming room on one side of the running live streaming client (or the streamer client). After the above steps, the plurality of streamers are located in the same three-dimensional live streaming room, and the image of the streamers is fused with the virtual environment, so as to provide better integrity and authenticity. Meanwhile, it enables the interaction and communication between the plurality of streamers in the three-dimensional live streaming room, and improve the interaction efficiency of the three-dimensional live streaming room.

In this embodiment, by creating the three-dimensional live streaming room ; based on the first video live stream sent by the first terminal device, a first target image is created in the three-dimensional live streaming room, where the first terminal device corresponds to a streamer, and the first target image represents a live streaming room image of a two-dimensional live streaming room corresponding to the first video live stream; and a second video live stream corresponding to the three-dimensional live streaming room is sent to the target terminal device, where the target terminal device includes the first terminal device and/or the second terminal device, and the second terminal device corresponds to the viewer. By creating the three-dimensional live streaming room, the image (streamer image) picture of the streamer is transmitted to the three-dimensional live streaming room for display, so that the image pictures of different streamers are fused with the environment, the space splitting is eliminated, the visual effect difference is improved, and the overall live streaming effect in the scene of multi-person live streaming is improved.

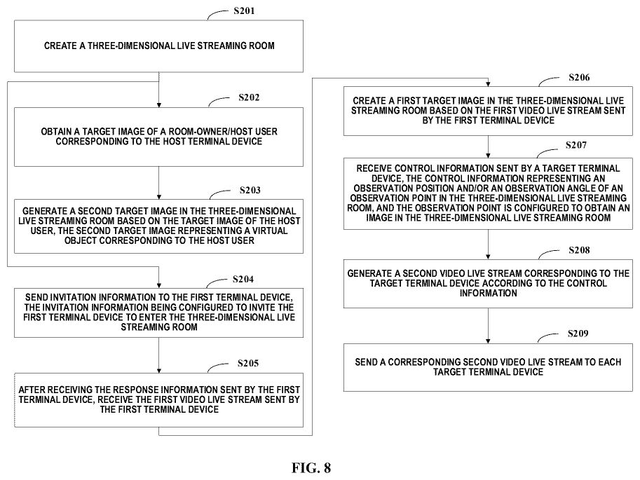

Referring to FIG. 8, FIG. 8 is a schematic flowchart 2 of a method of multi-person live video streaming according to an embodiment of the present disclosure. In this embodiment, based on the embodiment shown in FIG. 2, the step of processing based on the control information is further added, and the method of multi-person live video streaming includes the following steps.

Step S201, a three-dimensional live streaming room is created.

Step S202, a target picture of a room-owner/host user corresponding to the host terminal device is obtained.

Step S203, a second target image in the three-dimensional live streaming room is generated based on the target image of the host user, the second target image representing a virtual object corresponding to the host user.

For example, in this embodiment, after creating the three-dimensional live streaming room, the host terminal device further creates, in the three-dimensional live streaming room, a virtual object based on its own image as the host user of the three-dimensional live streaming room. Specifically, first, the host terminal device acquires the target picture of the host user on one side of the host terminal device through the image acquisition unit. Then, a streamer image feature is obtained based on the feature extraction. Then, the obtained streamer image feature is used as a parameter input to the three-dimensional image engine, so that a corresponding virtual object is rendered in the three-dimensional live streaming room, for example, a virtual character whose appearance is the host, i.e., the second target image.

Step S204, invitation information is sent to the first terminal device, where the invitation information is configured to invite the first terminal device to enter the three-dimensional live streaming room.

Step S205, after receiving the response information sent by the first terminal device, the first video live stream sent by the first terminal device is received.

Further, after the three-dimensional live streaming room is created, in a possible implementation, the host terminal device sends the invitation information to the first terminal device based on the user instruction, to invite the streamer on one side of the first terminal device to join the three-dimensional live streaming room. After receiving the invitation information, the first terminal device displays a corresponding prompt identifier and a corresponding selection component in the client of the live streaming application. The prompt identifier is, for example, the “XXX user invites you to join the XR live streaming room”, and the selection components displayed correspondingly present options of “yes” and “no”. After the streamer clicks the selection component corresponding to “yes”, the first terminal device sends the response information to the host terminal device. After receiving the response information, the host terminal device establishes a video connection with the first terminal device, and the first terminal device sends the video live stream corresponding to the live streaming room where the streamer user is currently located, that is, the first video live stream, to the host terminal device. Therefore, the host terminal device receives the first video live stream and performs subsequent processing steps.

Step S206, a first target image in the three-dimensional live streaming room is created based on the first video live stream sent by the first terminal device.

Step S207, control information sent by a target terminal device is received, where the control information represents an observation position and/or an observation angle of an observation point in the three-dimensional live streaming room, and the observation point is configured to obtain an image in the three-dimensional live streaming room.

Step S208, a second video live stream corresponding to the target terminal device is generated according to the control information.

For example, the target terminal device may be a first terminal device or a second terminal device, that is, a terminal device used by the streamer or the viewer. Both the streamer and the viewer may adjust the position and the viewing perspective of the live streaming image in the three-dimensional live streaming room through the corresponding terminal device (or the client running in the terminal device). In the following it will be described in detail from the viewer as an example. For example, after receiving the operation instruction of the viewer, the target terminal device sends the control information to the host terminal device. In some embodiments, the operation instructions include, for example, an instruction of rotating lens and an instruction of moving lens position. Through the above instruction of rotating lens and the instruction of moving a lens position, the position parameter and the angle parameter of the picture lens in the three-dimensional live streaming room may be obtained, that is, the control information. In some embodiments, the picture lens is the observation point in the three-dimensional live streaming room, the position parameter is information representing the observation position, and the angle parameter is information representing the observation angle. After receiving the control information, the host terminal device renders a corresponding two-dimensional image based on the observation position and/or the observation angle represented by the control information, in order to generate a second video live stream, and returns the second video live stream to the second terminal device. Therefore, the viewer on one side of the second terminal device can see the live streaming image matching the instruction of rotating lens and the instruction of moving a lens position instruction applied thereto.

It should be noted that the control information may include information corresponding to the observation position and the observation angle at the same time, or may only include information corresponding to the observation position or the observation angle. If the control information only includes information corresponding to the observation position or the observation angle, another parameter is automatically generated or fixedly set. For example, if the control information includes the parameter of the observation position, the observation angle may be automatically determined according to the observation position and the direction of the vector formed by the first spatial position where the first target image is located, so that the observation angle always faces the first target image. If the control information includes the parameter of the observation angle, the observation position may be a preset value which, for example, determined based on the previous instruction of moving a lens position. The specific implementation manner may be determined according to needs, details of which are not repeated herein again.

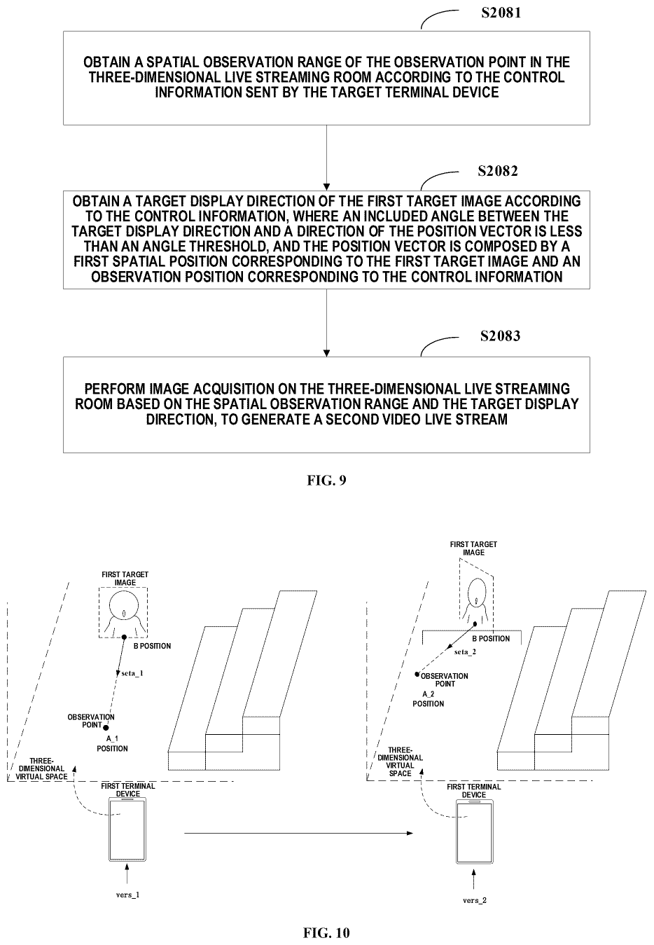

In a possible implementation, as shown in FIG. 9, step S208 includes three specific implementation steps of steps S2081, S2082, and S2083:

Step S2081, a spatial observation range of the observation point in the three-dimensional live streaming room is obtained according to the control information sent by the target terminal device.

Step S2082, a target display direction of the first target image according to the control information is obtained, where an included angle between the target display direction and a direction of the position vector is less than an angle threshold, and the position vector is composed by a first spatial position corresponding to the first target image and an observation position corresponding to the control information.

Step S2083, image acquisition is performed on the three-dimensional live streaming room based on the spatial observation range and the target display direction, to generate a second video live stream.

For example, the control information includes an observation position and an observation angle, and the positioning of the observation point in the three-dimensional live streaming room may be determined according to the observation position. Then, a spatial observation range may be determined according to the observation angle and a preset field of vision angle (for example, an angle range of 60 degrees up and down or about 120 degrees left and right around the observation angle taken as a center). In a possible implementation, if the first target image (the first spatial position where the first target image is located) is outside the spatial observation range, image acquisition and encoding are performed on the three-dimensional live streaming room based on the spatial observation range to generate a second video live stream composed of two-dimensional image frames. In a specific implementation process, each time a user inputs an operation instruction (for example, rotating the view angle), control information is generated at the target terminal device. After the control information being sent by the target terminal device, the host terminal device generates at least one frame of two-dimensional image frame based on the control information, and sends the at least one frame of two-dimensional image frame back to the target terminal device for display through the second video live stream, thereby generating an effect of three-dimensional view.

In another possible implementation, if the first target image (or the first spatial position where the first target image is located) is within the spatial observation range, the target display direction of the first target image is further obtained according to the control information. In some embodiments, the display direction of the first target image is the orientation of the first target image, and the target display direction of the first target image is determined by a direction of a position vector composed by the first spatial position corresponding to the first target image and the observation position corresponding to the control information. For example, the target display direction of the first target image is parallel to the direction of the position vector composed by the first spatial position and the observation position, or the included angle is less than the angle threshold. Then, image acquisition and encoding are performed on the three-dimensional live streaming room corresponding to the first target image and the spatial observation range displayed in the target display direction, to generate a second video live stream composed of the two-dimensional image frames. In the two-dimensional image frames of the second video live stream, the display direction of the first target image always faces the observation point, so that the problem of deflection of the first target image in the live streaming image due to the movement of the observation point is avoided, and the picture effect is improved.

FIG. 10 is a schematic diagram of determining a target display direction according to an embodiment of the present disclosure. The above steps are further described below with reference to FIG. 10. As shown in FIG. 10, according to the control information vers_1 (shown in FIG. 10 as vers_1) sent by the second terminal device, in the case where the observation point is set in A_1 position in the three-dimensional live streaming room, the target display direction of the first target image located at the B position is seta_1, where seta_1 is the connection line direction of A_1 position and the B position. The host terminal device captures the image of the three-dimensional live streaming room in the spatial observation range, and the first target image displayed in the display direction of seta_1, both of which are rendered fused and encoded to generate the second video live stream steam 1.

According to the control information vers_2 (shown as vers_2 in FIG. 10), in the case where the observation point is set in A_2 position in the three-dimensional live streaming room, the target display direction of the first target image located at the B position is seta_2, and the seta_2 is the connection line direction of A_2 position and the B position. The host terminal device captures an image of the three-dimensional live streaming room in the spatial observation range, and the first target image displayed in the display direction of seta_2, both of which are rendered fused and encoded to generate the second video live stream steam 2.

Based on the embodiment shown in FIG. 1, although the second video live stream steam 1 and the second video live stream steam_2 correspond to observation positions of different observation points, since the target display direction is dynamically adjusted along with the observation position, it is ensured that the first target image always faces the live streaming lens (observation point) in both the second video live stream steam_1 and the second video live stream steam_2. It ensures that the first target image can be normally displayed at any observation position.

Step S209, a corresponding second video live stream is sent to each target terminal device.

For example, after the second video live stream is generated, the second video live stream is sent to the first terminal device and/or the second terminal device, so that each streamer and each viewer entering the live streaming room can see a live streaming image generated based on the control information set by each of themselves.

In this embodiment, the steps S201, S206, S209 are consistent with implementations of steps S101-S103 in the foregoing embodiments, and details have been discussed with reference to the related discussion in the embodiment shown in FIG. 2, which are not repeated herein again.

According to the method, apparatus, and electronic device and storage medium of multi-person live video streaming, which includes creating the three-dimensional live streaming room; creating, based on the first video live stream sent by the first terminal device, a first target image in the three-dimensional live streaming room, where the first terminal device corresponds to a streamer, and the first target image represents a live streaming room image of a two-dimensional live streaming room corresponding to the first video live stream; and sending a second video live stream corresponding to the three-dimensional live streaming room to the target terminal device, where the target terminal device includes the first terminal device and/or the second terminal device, and the second terminal device corresponds to the viewer. By creating the three-dimensional live streaming room, the image (streamer image) picture of the streamer is transmitted to the three-dimensional live streaming room for display, so that the image pictures of different streamers are fused with the environment, which eliminates the space splitting, improves the visual effect difference and the overall live streaming effect in the scene of multi-person live streaming.

Referring to FIG. 11, FIG. 11 is a schematic flowchart 3 of a method of multi-person live video streaming according to an embodiment of the present disclosure. The method of the embodiment may be applied at a first terminal device used by a streamer. For example, the method of multi-person live video streaming provided in this embodiment includes the following steps.

Step S301, a three-dimensional live streaming room is entered.

Step S302, a first video live stream is sent to a host terminal device that creates a three-dimensional live streaming room, to create a first target image in the three-dimensional live streaming room, where the first target image represents a live streaming room picture of a two-dimensional live streaming room corresponding to the first video live stream.

Step S303, a second video live stream corresponding to the three-dimensional live streaming room is received, and the second video live stream is played.

For example, in the method provided in this embodiment, the first terminal device on one side of the streamer is the execution main body, and after entering the three-dimensional live streaming room, the first terminal device sends the first video live stream to the host terminal device, so that the live streaming image of the streamer is generated in the three-dimensional live streaming room. Then, the second video live stream generated after the host terminal device renders the three-dimensional live streaming room is received, and the second video live stream is played based on the second video live stream, to implement the streamer connection of different streamers in the three-dimensional virtual environment. Since each streamer can see the streamer images of themselves and other streamers through the above steps, live streaming interaction in a three-dimensional environment can be realized, and the live streaming effect of multi-person live streaming can be improved. For a specific implementation process of the foregoing steps, reference may be made to an interaction step between the host terminal device and the first terminal device in the foregoing embodiments, details of which are not described herein again.

Further, based on this, the method provided in this embodiment further includes the following steps:

Step S304, control information is sent, where the control information represents an observation position and/or an observation angle of an observation point in the three-dimensional live streaming room, and the observation point is configured for obtaining an image in the three-dimensional live streaming room.

After the control information is sent, the specific implementation of step S303 is: receiving a second video live stream generated based on the control information corresponding to the three-dimensional live streaming room, and playing the second video live stream.

For example, after the streamer joins the three-dimensional live streaming room, the control information may be further sent to the host terminal device by operating the first terminal device, so as to control the observation position and angle of the observation point in the three-dimensional live streaming room, thereby achieving better interaction effect with other streamers. For a specific implementation, reference may be made to the related steps in which the second terminal device sends the control information to the host terminal device in the foregoing embodiment, and the implementation manner is similar, details of which are not repeated herein again.

Corresponding to the method of multi-person live video streaming in the foregoing embodiment, FIG. 12 is a structural block diagram of an apparatus for multi-person live video streaming according to an embodiment of the present disclosure, which is applied at a host terminal device. For ease of illustration, only portions related to embodiments of the present disclosure are shown. Referring to FIG. 12, the apparatus 4 for multi-person live video streaming includes the following modules.

A creating module 41 is configured to create a three-dimensional live streaming room.

A generating module 42 is configured to create a first target image in the three-dimensional live streaming room based on a first video live stream sent by a first terminal device, where the first terminal device corresponds to a streamer, and the first target image represents a live streaming room picture of a two-dimensional live streaming room corresponding to the first video live stream.

A transceiving module 43 is configured to send a second video live stream corresponding to the three-dimensional live streaming room to a target terminal device, where the target terminal device includes the first terminal device and/or a second terminal device, and the second terminal device corresponds to a viewer.

In an embodiment of the present disclosure, the generating module 42 is specifically configured to determine a target region of a live streaming image frame in the first video live stream, the target region being a region where a streamer image locates in the live streaming image frame; generate the first target image by segmenting the live streaming image frame based on the target region; and set the first target image into the three-dimensional live streaming room.

In an embodiment of the present disclosure, the generating module 42 is further configured to receive control information sent by the target terminal device, where the control information represents an observation position and/or an observation angle of an observation point in the three-dimensional live streaming room, and the observation point is configured to obtain an image in the three-dimensional live streaming room; and generate the second video live stream corresponding to the target terminal device according to the control information.

In an embodiment of the present disclosure, when generating the second video live stream corresponding to the target terminal device according to the control information, the generating module 42 is specifically configured to obtain a spatial observation range of the observation point in the three-dimensional live streaming room according to the control information sent by the target terminal device; and generate the second video live stream by performing image acquisition on the three-dimensional live streaming room based on the spatial observation range.

In an embodiment of the present disclosure, when generating the second video live stream corresponding to the target terminal device according to the control information, the generating module 42 is specifically configured to obtain a target display direction of the first target image according to the control information, where an included angle between the target display direction and a direction of the position vector is less than an angle threshold, and the position vector is composed by a first spatial position corresponding to the first target image and an observation position corresponding to the control information; and generate the second video live stream according to the target display direction.

In an embodiment of the present disclosure, the three-dimensional live streaming room includes at least one first spatial position and/or at least one second spatial position, where the first spatial position is used to display a first target image, the second spatial position is used to display a virtual object, the first spatial position is determined based on first request information of a streamer entering the three-dimensional live streaming room, and the second spatial position is determined based on second request information of a viewer entering the three-dimensional live streaming room.

In an embodiment of the present disclosure, the generating module 42 is further configured to obtain first request information of a target viewer entering the three-dimensional live streaming room; obtain a target appearance of the corresponding target virtual object based on the first request information; and generate a target virtual object based on the target appearance.

In an embodiment of the present disclosure, the generating module 42 is further configured to: in response to the action request sent by the second terminal device, obtain action information corresponding to the target viewer; generate a target action of the target virtual object corresponding to the target viewer based on the action information; and control the target virtual object to move in the three-dimensional live streaming room based on the target action.

In an embodiment of the present disclosure, the generation module 42 is further configured to obtain a target picture of a host user corresponding to the host terminal device; generate a second target image in the three-dimensional live streaming room based on the target picture of the host user, where the second target image represents a virtual object corresponding to the host user.

In an embodiment of the present disclosure, after creating the three-dimensional live streaming room, the transceiving module 43 is further configured to send invitation information to the first terminal device, where the invitation information is used to invite the first terminal device to enter the three-dimensional live streaming room; and after the response information sent by the first terminal device is received, receive the first video live stream sent by the first terminal device.

The creating module 41, the generating module 42, and the transceiving module 43 are connected in sequence. The apparatus 4 for multi-person live video streaming provided in this embodiment may perform the technical solutions of the foregoing method embodiments, and implementation principles and technical effects thereof are similar, details of which are not described herein again in this embodiment.

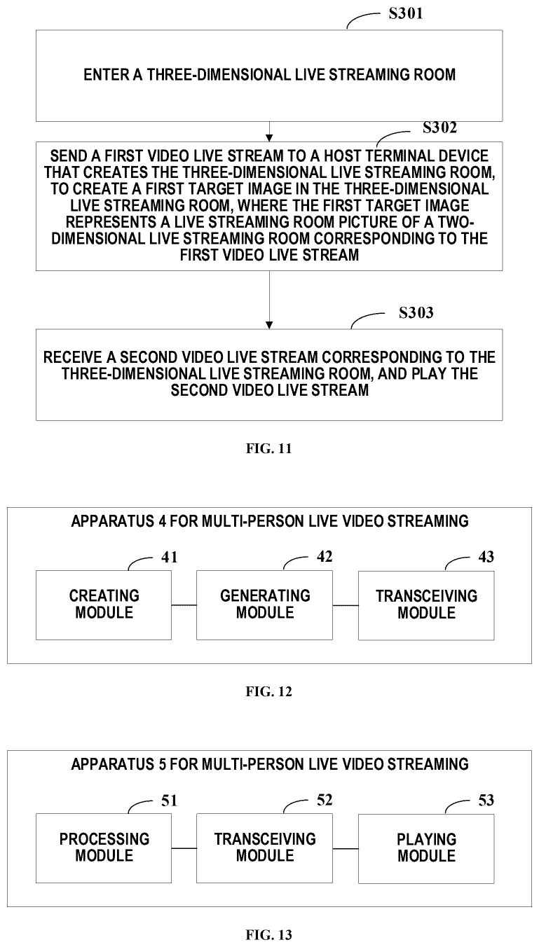

FIG. 13 is a structural block diagram of another apparatus for multi-person live video streaming according to an embodiment of the present disclosure, which is applied at a first terminal device. For ease of illustration, only portions related to embodiments of the present disclosure are shown. Referring to FIG. 13, the apparatus 5 for multi-person live video streaming includes:

A processing module 51 is configured to enter a three-dimensional live streaming room.

A transceiving module 52 is configured to send a first video live stream to a host terminal device which is configured to create the three-dimensional live streaming room, to create a first target image in the three-dimensional live streaming room, the first target image represents an streamer image picture in the first video live stream.

A playing module 53 is configured to receive a second video live stream corresponding to the three-dimensional live streaming room, and play the second video live stream.

In an embodiment of the present disclosure, the transceiving module 52 is further configured to send control information, where the control information represents an observation position and/or an observation angle of an observation point in the three-dimensional live streaming room, and the observation point is configured to obtain an image in the three-dimensional live streaming room; and the play module 53 is specifically configured to: receive a second video live stream generated based on the control information corresponding to the three-dimensional live streaming room, and play the second video live stream generated based on the control information.

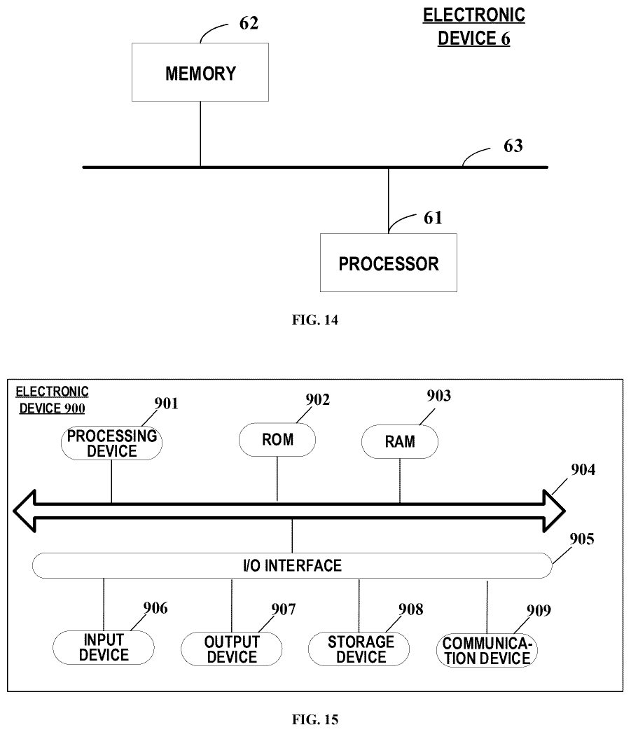

FIG. 14 is a schematic structural diagram of an electronic device according to an embodiment of the present disclosure, as shown in FIG. 14, the electronic device 14 includes: a processor 61, and a memory 62 communicatively connected to the processor 61; the memory 62 storing computer-executable instructions, and the processor 61 executes the computer-executable instructions stored by the memory 62, to implement the method of multi-person live video streaming according to FIG. 2 to FIG. 11.

In some embodiments, optionally, the processor 61 and the memory 62 are connected by using a bus 63.

Related descriptions may be understood with reference to related descriptions and effects corresponding to the steps in the embodiments corresponding to FIG. 2 to FIG. 11, details of which are not described herein again.

An embodiment of the present disclosure provides a computer-readable storage medium, where the computer-readable storage medium stores computer-executable instructions, and when the computer-executable instructions are executed by a processor, the computer-executable instructions are configured to implement the method of multi-person live video streaming provided in any of the embodiments corresponding to FIG. 2 to FIG. 11 of the present disclosure.

An embodiment of the present disclosure provides a computer program product, including a computer program, where the computer program, when executed by a processor, implements the method of multi-person live video streamin in the embodiments shown in FIG. 2 to FIG. 11.

FIG. 15 shows a schematic structural diagram of an electronic device 900 suitable for implementing embodiments of the present disclosure, and the electronic device 900 may be a terminal device or a server. The terminal device may include, but is not limited to, a mobile terminal such as a mobile phone, a notebook computer, a digital broadcast receiver, a personal digital assistant (PDA), a tablet computer (PAD), a portable multimedia player (PMP), an in-vehicle terminal (for example, an in-vehicle navigation terminal), and a fixed terminal such as a digital TV, a desktop computer, or the like. The electronic device shown in FIG. 15 is merely an example, and should not impose any limitation on the functions and scope of use of the embodiments of the present disclosure.

As shown in FIG. 15, the electronic device 900 may include a processing device (for example, a central processing unit, a graphics processor, etc.) 901, which may perform various appropriate actions and processing according to a program stored in a read only memory (ROM) 902 or a program loaded into a random access memory (RAM) 903 from a storage device 908. In the RAM 903, various programs and data required by the operation of the electronic device 900 are also stored. The processing device 901, the ROM 902, and the RAM 903 are connected to each other through a bus 904. Input/output (I/O) interface 905 is also connected to bus 904.

Generally, the following devices may be connected to the I/O interface 905: an input device 906 including, for example, a touch screen, a touch pad, a keyboard, a mouse, a camera, a microphone, an accelerometer, a gyroscope, etc.; an output device 907 including, for example, a liquid crystal display (LCD), a speaker, a vibrator, etc.; a storage device 908 including, for example, a magnetic tape, a hard disk, etc.; and a communication device 909. The communication device 909 may allow the electronic device 900 to communicate wirelessly or wired with other devices to exchange data. While FIG. 15 shows an electronic device 900 having various devices, it should be understood that it is not required to implement or have all illustrated devices. More or fewer devices may alternatively be implemented or provided.

In particular, according to an embodiment of the present disclosure, the process described above with reference to the flowchart may be implemented as a computer software program. For example, embodiments of the present disclosure include a computer program product including a computer program embodied on a computer readable medium, the computer program including program code for performing the method shown in the flowchart. In such embodiments, the computer program may be downloaded and installed from the network through the communication device 909, or installed from the storage device 908, or from the ROM 902. When the computer program is executed by the processing apparatus 901, the foregoing functions defined in the method of the embodiments of the present disclosure are performed.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including, but not limited to: wires, optical cables, RF (radio frequency), and the like, or any suitable combination of the foregoing.

The computer-readable medium described above may be included in the electronic device; or may be separately present without being assembled into the electronic device.

The computer-readable medium carries one or more programs, and when the one or more programs are executed by the electronic device, the electronic device is enabled to perform the method shown in the foregoing embodiments.

Computer program code for performing the operations of the present disclosure may be written in one or more programming languages, including object oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (for example, using an Internet service provider for Internet connection).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. For example, the first obtaining unit may be further described as “a unit for obtaining at least two Internet Protocol addresses”.

The functions described above may be performed, at least in part, by one or more hardware logic components. For example, without limitation, example types of hardware logic components that may be used include: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

In a first aspect, a method of multi-person live video streaming is provided according to one or more embodiments of the present disclosure, including: creating a three-dimensional live streaming room; creating a first target image in the three-dimensional live streaming room based on a first video live stream sent by a first terminal device, where the first terminal device corresponds to a streamer, and the first target image represents a live streaming room picture of a two-dimensional live streaming room corresponding to the first video live stream; and sending a second video live stream corresponding to the three-dimensional live streaming room to a target terminal device, where the target terminal device includes the first terminal device and/or a second terminal device, and the second terminal device corresponds to a viewer.

According to one or more embodiments of the present disclosure, the creating the first target image in the three-dimensional live streaming room based on the first video live stream sent by the first terminal device includes: determining a target region of a live streaming image frame in the first video live stream, the target region being a region where a streamer image locates in the live streaming image frame; generating the first target image by segmenting the live streaming image frame based on the target region; setting the first target image into the three-dimensional live streaming room.

According to one or more embodiments of the present disclosure, the method further includes: receiving control information sent by the target terminal device, the control information represents an observation position and/or an observation angle of an observation point in the three-dimensional live streaming room, and the observation point is configured to obtain an image in the three-dimensional live streaming room; and generating the second video live stream according to the control information.

According to one or more embodiments of the present disclosure, the generating the second video live stream according to the control information includes: obtaining a spatial observation range of the observation point in the three-dimensional live streaming room according to control information sent by the target terminal device; and generating the second video live stream by performing image acquisition on the three-dimensional live streaming room based on the spatial observation range.

According to one or more embodiments of the present disclosure, the generating the second video live stream according to the control information includes: obtaining a target display direction of the first target image according to the control information, where an included angle between the target display direction and a direction of the position vector is less than an angle threshold, and the position vector is composed by a first spatial position corresponding to the first target image and an observation position corresponding to the control information; and generating the second video live stream according to the target display direction.

According to one or more embodiments of the present disclosure, the three-dimensional live streaming room includes at least one first spatial position and/or at least one second spatial position, where the first spatial position is used to display a first target image, the second spatial position is used to display a virtual object, the first spatial position is determined based on first request information of a streamer entering the three-dimensional live streaming room, and the second spatial position is determined based on second request information of a viewer entering the three-dimensional live streaming room.

According to one or more embodiments of the present disclosure, the method further includes: obtaining first request information of a target viewer entering the three-dimensional live streaming room; obtaining a target appearance of the corresponding target virtual object based on the first request information; and generating a target virtual object based on the target appearance.

According to one or more embodiments of the present disclosure, the method further includes: in response to the action request sent by the second terminal device, obtaining action information corresponding to the target viewer; generating a target action of the target virtual object corresponding to the target viewer based on the action information; and controlling the target virtual object to move in the three-dimensional live streaming room based on the target action.

According to one or more embodiments of the present disclosure, the method further includes: obtaining a target picture of a host user corresponding to the host terminal device; generating a second target image in the three-dimensional live streaming room based on the target picture of the host user, where the second target image represents a virtual object corresponding to the host user.

According to one or more embodiments of the present disclosure, after creating the three-dimensional live streaming room, the method further includes: sending invitation information to the first terminal device, where the invitation information is used to invite the first terminal device to enter the three-dimensional live streaming room; and after the response information sent by the first terminal device is received, receiving the first video live stream sent by the first terminal device.

In a second aspect, a method of multi-person live video streaming is provided according to one or more embodiments of the present disclosure, including: entering a three-dimensional live streaming room; sending a first video live stream to a host terminal device which is configured to create the three-dimensional live streaming room, to create a first target image in the three-dimensional live streaming room, the first target image represents an streamer image picture in the first video live stream; and receiving a second video live stream corresponding to the three-dimensional live streaming room, and playing the second video live stream.

According to one or more embodiments of the present disclosure, the method further includes: sending control information, where the control information represents an observation position and/or an observation angle of an observation point in the three-dimensional live streaming room, and the observation point is used to obtain an image in the three-dimensional live streaming room; the receiving a second video live stream corresponding to the three-dimensional live streaming room, and playing the second video live stream includes: receiving a second video live stream generated based on the control information corresponding to the three-dimensional live streaming room, and playing the second video live stream generated based on the control information.

In a third aspect, an apparatus for multi-person live video streaming is provided according to one or more embodiments of the present disclosure, including: a creation module creating module configured to create a three-dimensional live streaming room; a generating module configured to create a first target image in the three-dimensional live streaming room based on a first video live stream sent by a first terminal device, where the first terminal device corresponds to a streamer, and the first target image represents a live streaming room picture of a two-dimensional live streaming room corresponding to the first video live stream; and transceiving module configured to send a second video live stream corresponding to the three-dimensional live streaming room to a target terminal device, where the target terminal device includes the first terminal device and/or a second terminal device, and the second terminal device corresponds to a viewer.

According to one or more embodiments of the present disclosure, the generating module is specifically configured to: determining a target region of a live streaming image frame in the first video live stream, the target region being a region where a streamer image locates in the live streaming image frame; generating the first target image by segmenting the live streaming image frame based on the target region; and setting the first target image into the three-dimensional live streaming room.

According to one or more embodiments of the present disclosure, the generating module is further configured to: receiving control information sent by the target terminal device, where the control information represents an observation position and/or an observation angle of an observation point in the three-dimensional live streaming room, and the observation point is configured to obtain an image in the three-dimensional live streaming room; and generating the second video live stream corresponding to the target terminal device according to the control information.

According to one or more embodiments of the present disclosure, when generating the second video live stream according to the control information, the generating module is specifically configured to: obtaining a spatial observation range of the observation point in the three-dimensional live streaming room according to the control information sent by the target terminal device; and generating the second video live stream by performing image acquisition on the three-dimensional live streaming room based on the spatial observation range.

According to one or more embodiments of the present disclosure, when generating the second video live stream according to the control information, the generating module is specifically configured to: obtaining a target display direction of the first target image according to the control information, where an included angle between the target display direction and a direction of the position vector is less than an angle threshold, and the position vector is composed by a first spatial position corresponding to the first target image and an observation position corresponding to the control information; and generating the second video live stream according to the target display direction.

According to one or more embodiments of the present disclosure, the three-dimensional live streaming room includes at least one first spatial position and/or at least one second spatial position, where the first spatial position is used to display a first target image, the second spatial position is used to display a virtual object, the first spatial position is determined based on first request information of a streamer entering the three-dimensional live streaming room, and the second spatial position is determined based on second request information of a viewer entering the three-dimensional live streaming room.

According to one or more embodiments of the present disclosure, the generating module is further configured to: obtaining first request information of a target viewer entering the three-dimensional live streaming room; obtaining a target appearance of the corresponding target virtual object based on the first request information; and generating a target virtual object based on the target appearance.

According to one or more embodiments of the present disclosure, the generating module is further configured to: in response to the action request sent by the second terminal device, obtaining action information corresponding to the target viewer; generating a target action of the target virtual object corresponding to the target viewer based on the action information; and controlling the target virtual object to move in the three-dimensional live streaming room based on the target action.

According to one or more embodiments of the present disclosure, the generation module is further configured to: obtaining a target picture of a host user corresponding to the host terminal device; generating a second target image in the three-dimensional live streaming room based on the target picture of the host user, where the second target image represents a virtual object corresponding to the host user.

According to one or more embodiments of the present disclosure, after creating the three-dimensional live streaming room, the transceiving module is further configured to: sending invitation information to the first terminal device, where the invitation information is used to invite the first terminal device to enter the three-dimensional live streaming room; and after the response information sent by the first terminal device is received, receiving the first video live stream sent by the first terminal device.

In a fourth aspect, an apparatus for multi-person live video streaming is provided according to one or more embodiments of the present disclosure, including: a processing module configured to enter a three-dimensional live streaming room; a transceiving module, configured to send a first video live stream to a host terminal device which is configured to create the three-dimensional live streaming room, to create a first target image in the three-dimensional live streaming room, the first target image represents an streamer image picture in the first video live stream; and a playing module configured to receive a second video live stream corresponding to the three-dimensional live streaming room, and play the second video live stream.

According to one or more embodiments of the present disclosure, the transceiving module is further configured to: sending control information, where the control information represents an observation position and/or an observation angle of an observation point in the three-dimensional live streaming room, and the observation point is configured to obtain an image in the three-dimensional live streaming room; and the playing module 53 is specifically configured to: receiving a second video live stream generated based on the control information corresponding to the three-dimensional live streaming room, and playing the second video live stream generated based on the control information.

In a fifth aspect, an electronic device is provided according to one or more embodiments of the present disclosure, including: a processor, and a memory communicatively connected to the processor; the memory storing computer-executable instructions; the processor executing the computer-executable instructions stored in the memory, to implement the method of multi-person live video streaming according to the first aspect and various possible designs of the first aspect, or to implement the method of multi-person live video streaming according to the second aspect and the possible designs of the second aspect.

In a sixth aspect, a computer-readable storage medium is provided according to one or more embodiments of the present disclosure, the computer-readable storage medium storing computer-executable instructions, and when the processor executes the computer-executable instruction, the method of multi-person live video streaming according to the first aspect and the possible designs of the first aspect is implemented, or the method of multi-person live video streaming according to the second aspect and the possible designs of the second aspect is implemented.

In a seventh aspect, an embodiment of the present disclosure provides a computer program product, including a computer program which, when executed by a processor, implements the method of multi-person live video streaming according to the first aspect and various possible designs of the first aspect, or implements the method of multi-person live video streaming according to the second aspect and the possible designs of the second aspect.

The above description is merely an illustration of the preferred embodiments of the present disclosure and the principles of the applied technology. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and or methodological acts, it is to be understood that the subject matter defined in the appended claims is not necessarily limited to the specific features or acts described above. Rather, the specific features and acts described above are merely illustrative forms of implementing the claims.

1. A method of multi-person live video streaming, comprising:
creating a three-dimensional live streaming room;
creating a first target image in the three-dimensional live streaming room based on a first video live stream sent by a first terminal device, wherein the first terminal device corresponds to a streamer, and the first target image represents a live streaming room picture of a two-dimensional live streaming room corresponding to the first video live stream;
sending a second video live stream corresponding to the three-dimensional live streaming room to a target terminal device, wherein the target terminal device comprises the first terminal device and/or a second terminal device, and the second terminal device corresponds to a viewer.

2. The method of claim 1, wherein the creating the first target image in the three-dimensional live streaming room based on the first video live stream sent by the first terminal device comprises:
determining a target region of a live stream image frame in the first video live stream, the target region being a region where a streamer image locates in the live stream image frame;
generating the first target image by segmenting the live stream image frame based on the target region;
setting the first target image into the three-dimensional live streaming room.

3. The method of claim 1, wherein the method further comprises:
receiving control information sent by the target terminal device;
generating the second video live stream according to the control information.

4. The method of claim 3, wherein the generating the second video live stream according to the control information comprises:
generating the second video live stream by performing image acquisition on the three-dimensional live streaming room according to the control information sent by the target terminal device.

5. The method of claim 3, wherein the generating the second video live stream according to the control information comprises:
obtaining a target display direction of the first target image according to the control information;
generating the second video live stream according to the target display direction.

6. The method of claim 1, wherein the three-dimensional live streaming room comprises at least one first spatial position and/or at least one second spatial position, wherein the first spatial position is configured to display the first target image, the second spatial position is configured to display a virtual object, the first spatial position being determined based on first request information of a streamer entering the three-dimensional live streaming room, and the second spatial position being determined based on second request information of a viewer entering the three-dimensional live streaming room.

7. The method of claim 6, wherein the method further comprises:
obtaining the first request information of a target viewer entering the three-dimensional live streaming room;
obtaining a target appearance of a corresponding target virtual object based on the first request information;
generating the target virtual object based on the target appearance.

8. The method of claim 6, wherein the method further comprises:
obtaining, in response to an action request sent by the second terminal device, action information corresponding to a target viewer;
generating a target action of the target virtual object corresponding to the target viewer based on the action information;
controlling the target virtual object to move in the three-dimensional live streaming room based on the target action.

9. The method of claim 1, wherein the method further comprises:
obtaining a target image of a host user corresponding to a host terminal device;
generating a second target image in the three-dimensional live streaming room based on the target image of the host user, the second target image representing the virtual object corresponding to the host user.

10. The method of claim 1, wherein after creating the three-dimensional live streaming room, the method further comprises:
sending invitation information to the first terminal device, the invitation information being configured to invite the first terminal device to enter the three-dimensional live streaming room;
receiving the first video live stream sent by the first terminal device after receiving the response information sent by the first terminal device.

11. A method of multi-person live video streaming, comprising:
entering a three-dimensional live streaming room;
sending a first video live stream to a host terminal device which is configured to create the three-dimensional live streaming room, to create a first target image in the three-dimensional live streaming room, wherein the first target image represents an streamer image picture in the first video live stream;
receiving a second video live stream corresponding to the three-dimensional live streaming room, and playing the second video live stream.

12. The method of claim 11, wherein the method further comprises:
sending control information;
the receiving the second video live stream corresponding to the three-dimensional live streaming room, and playing the second video live stream comprises:
receiving the second video live stream corresponding to the three-dimensional live streaming room which is generated based on the control information, and playing the second video live stream generated based on the control information.

13-14. (canceled)

15. An electronic device, comprising: a processor, and a memory communicatively connected to the processor;
the memory storing computer-executable instructions;
the processor executing the computer-executable instructions stored in the memory, to implement acts comprising:
creating a three-dimensional live streaming room;
creating a first target image in the three-dimensional live streaming room based on a first video live stream sent by a first terminal device, wherein the first terminal device corresponds to a streamer, and the first target image represents a live streaming room picture of a two-dimensional live streaming room corresponding to the first video live stream;
sending a second video live stream corresponding to the three-dimensional live streaming room to a target terminal device, wherein the target terminal device comprises the first terminal device and/or a second terminal device, and the second terminal device corresponds to a viewer.

16. A non-transitory computer-readable storage medium, the computer-readable storage medium storing computer-executable instructions, and when the processor executes the computer-executable instructions, implementing acts comprising:
creating a three-dimensional live streaming room;
creating a first target image in the three-dimensional live streaming room based on a first video live stream sent by a first terminal device, wherein the first terminal device corresponds to a streamer, and the first target image represents a live streaming room picture of a two-dimensional live streaming room corresponding to the first video live stream;
sending a second video live stream corresponding to the three-dimensional live streaming room to a target terminal device, wherein the target terminal device comprises the first terminal device and/or a second terminal device, and the second terminal device corresponds to a viewer.

17. (canceled)

18. The electronic device of claim 15, wherein the creating the first target image in the three-dimensional live streaming room based on the first video live stream sent by the first terminal device comprises:
determining a target region of a live stream image frame in the first video live stream, the target region being a region where a streamer image locates in the live stream image frame;
generating the first target image by segmenting the live stream image frame based on the target region;
setting the first target image into the three-dimensional live streaming room.

19. The electronic device of claim 15, wherein the acts further comprise:
receiving control information sent by the target terminal device;
generating the second video live stream according to the control information.

20. The electronic device of claim 19, wherein the generating the second video live stream according to the control information comprises:
generating the second video live stream by performing image acquisition on the three-dimensional live streaming room according to the control information sent by the target terminal device.

21. The electronic device of claim 19, wherein the generating the second video live stream according to the control information comprises:
obtaining a target display direction of the first target image according to the control information;
generating the second video live stream according to the target display direction.

22. The electronic device of claim 15, wherein the three-dimensional live streaming room comprises at least one first spatial position and/or at least one second spatial position, wherein the first spatial position is configured to display the first target image, the second spatial position is configured to display a virtual object, the first spatial position being determined based on first request information of a streamer entering the three-dimensional live streaming room, and the second spatial position being determined based on second request information of a viewer entering the three-dimensional live streaming room.

23. The electronic device of claim 22, wherein the acts further comprise:
obtaining the first request information of a target viewer entering the three-dimensional live streaming room;
obtaining a target appearance of a corresponding target virtual object based on the first request information;
generating the target virtual object based on the target appearance.
